(19) United States
(12) Patent Application Publication
(10) Pub. No.: US 2007/0088871 A1
(43) Pub. Date: Apr. 19, 2007

(54) Implementation of shared and persistent job queues

(76) Inventors: Man K. Kwong, Naperville, IL (US); Roberta C. Kwong, Naperville, IL (US)

Correspondence Address: FAY SHARPE/LUCENT, 1100 SUPERIOR AVE, SEVENTH FLOOR, CLEVELAND, OH, 44114, US

(21) Appl. No.: 11/240,731

(22) Filed: Sep. 30, 2005

(51) Int. Cl. G06F 3/00

(52) U.S. Cl. 710/39

(57) ABSTRACT

A method is provided in a software program (20) for implementing a job queue (10) shared by a plurality of distinct processes (22). The method includes: adding a plurality of distinct jobs to the queue; and, providing the plurality of processes access to the job queue such that two different processes may simultaneously manipulate two different jobs contained in the job queue. Optionally, the queue is also persistent insomuch as it survives the exiting or termination of the process or processes that created it and/or first used it.

### FIELD

The present inventive subject matter relates to the computer software arts and more specifically to job queues used by software programs. Particular application is found in conjunction with operation, administration, and/or maintenance software for telecommunications equipment and/or software for the diagnostic testing of hardware in general, and the specification makes particular reference thereto. However, it is to be appreciated that aspects of the present inventive subject matter are also amenable to other applications.

### BACKGROUND

In general, the use of traditional job queues-is well-known in the software arts. For example, a time-sharing operating system typically maintains a queue of system processes and/or user requests. Using some suitable algorithm or logic, the operating system determines which jobs in the queue are processed in particular time-sharing slots. In such cases, the central issues tend to focus on how priorities are assigned to the various jobs and how the time slots are allotted so that all the jobs in the queue will eventually be addressed. Job queues in general have been traditionally implemented using rather involved coding techniques and a compiled language such as the C programming language.

For operating system software and the like that is typically complicated and/or resides in the lower architecture layers, execution speed is often a priority and job queues are commonly implemented as link lists that exist in memory. Implementing a job queue in this way requires rather involved and lengthy coding. On the contrary, in the case of operation, administration, and maintenance software for telecommunication equipment and/or software for the diagnostic testing of hardware in general, execution speed is often of less concern, while faster software development turnaround tends to have a higher priority. Accordingly, in certain circumstances it may be advantageous to have a relatively simpler implementation of a job queue, even at the potential expense of lower execution speed.

As is commonly understood in the computer software arts, a process is generally created to execute a task or set of instructions defined in a software program. For example, running a relatively simple software program may only result in a single process being spawned or created. A more complicated program however may sometimes create several distinct processes each working on one of a plurality of tasks of the program. Normally, these distinct processes do not share data with each other; e.g., because the modification of some shared data by one process, if not done with considerable care, may adversely affect the operation of another process. On the other hand, the sharing of data between two or more distinct processes can be otherwise advantageous. Accordingly, in connection with more general applications, there have been a variety of ways developed to achieve data sharing between otherwise separate or distinct processes, and these are traditionally known as Inter-Process Communication (IPC), including the techniques of “shared memory,” “message passing,” and “sockets.” Although these techniques can be quite efficient, they are not suitable for and/or not convenient to employ in connection with job queues, as those of ordinary skill in the art can readily appreciate. Accordingly, in traditional implementations, job queues are generally not shared among multiple distinct processes, but rather, a particular job queue is typically only accessible by or implemented within a single process which is associated with that job queue.

Normally, the internal data used by a process exists in volatile random access memory (RAM), and only for as long as the process is still running. Once a process is completed and has exited or ceased to exist, the data is erased from the memory or otherwise discarded or lost. Accordingly, a new process that is started after the fact will not be able to access that old data. In more general applications, if the preservation of the data is desired, the IPC “shared memory” technique mentioned above has been traditionally used, but again it is not convenient to use this technique in connection with the implementation of job queues.

For very simple textual data, one solution or technique to achieve data persistence is to write the text into an output file. For more recently developed object-oriented software that often employs more complicated objects as data, many techniques have also been developed which “dump” the object data into a file in such a format that another process can later read the file and reconstruct the same object. This process is commonly known as the recording of “persistent objects”. The aforementioned techniques, however, are not suitable to the implementation job queues; e.g., because the data that are dumped or written to the file are only images (or translated versions) of the real objects and not the objects themselves. Accordingly, they cannot be used directly by another process, rather the process has to first reconstruct them back into objects understood by the coding language. In particular, it is difficult for a process to edit or modify a part of the data or a particular one of the persistent objects dumped in the file. For example, presuming that the file corresponds to the queue and the dumped data therein corresponds to jobs in the queue, then editing part of the file (i.e., a particular job within the file) will tend to undesirably result in locking the whole queue (i.e., since the job or edited portion is part of the whole file or queue).

In any event, a suitable and/or sufficiently simple implementation of a shared and persistent job queue has not heretofore been developed. Accordingly, a new and improved implementation of shared and persistent job queues for software programs is disclosed that overcomes the above-referenced problems and others.

### SUMMARY

In accordance with one embodiment, a method is provided in a software program for implementing a job queue shared by a plurality of distinct processes. The method includes: adding a plurality of distinct jobs to the queue; and, providing the plurality of processes access to the job queue such that two different processes may simultaneously manipulate two different jobs contained in the job queue.

In accordance with another aspect, a software program running on a device is provided to perform diagnostic tests. The software program includes: a main process that acts as an interface with a user, the main process having as its responsibility receiving requests for tests from the user such that upon receipt of a request for a test the main process places a corresponding job associated with the test in a job queue; a daemon process which is launched by the main process to manage the job queue, the daemon process determining when jobs in the job queue are ready to be processed; and, a plurality of distinct agent processes that are launched by the daemon process when the daemon process determines that jobs are ready to be processed, each of the agent processes being dedicated to processing a single job so as to run the test associated with the job. Suitably, the job queue is implemented so that any two different processes may simultaneously manipulate any two different jobs.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating example embodiments and are not to be construed as limiting. Further, it is to be appreciated that the drawings are not to scale.

FIG. 1 is a diagram illustrating an exemplary general application software program implementing a shared job queue in accordance with aspects of the present inventive subject matter.

FIG. 2 is a diagram illustrating an exemplary diagnostic software program for testing hardware which implements a shared job queue in accordance with aspects of the present inventive subject matter.

FIGS. 3A-3D are flow charts showing exemplary approaches for executing various operations in connection with an exemplary implementation of a shared job queue as shown in FIGS. 1 and/or 2.

### DETAILED DESCRIPTION OF PREFERRED EMBODIMENTS

For clarity and simplicity, the present specification shall refer to structural, logical and/or functional elements, entities and/or facilities, relevant standards, protocols and/or services, and other components and features that are commonly known in the art without further detailed explanation as to their configuration or operation except to the extent they have been modified or altered in accordance with and/or to accommodate the embodiment(s) presented herein.

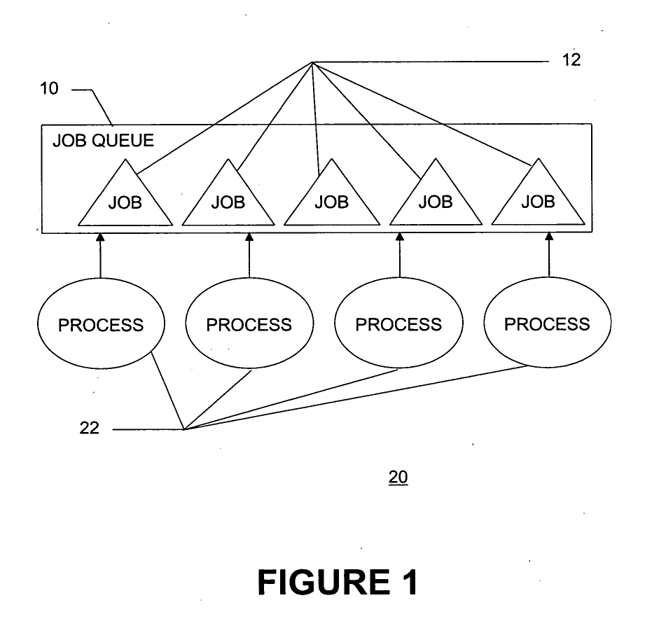

With reference to FIG. 1, there is shown a job queue 10 containing a plurality of distinct or separate jobs 12 which are, e.g., represented by distinct or separate job objects. Suitably, the job queue 10 is associated with an application or other software program 20 which is running on a computer or some other suitable hardware device. While not shown, the computer or other hardware device is equipped and/or arranged in the usual fashion to support the running software programs and to support their associated processes, jobs, objects, queues, etc. For example, the computer or other hardware device is optionally provisioned with a central processing unit (CPU) or other like processor, an operating system, RAM, non-volatile storage devices and/or memory, user input and/or output devices (e.g., a display or monitor, a keyboard, a mouse and/or other pointing devices, a graphic user interface (GUI), etc.), and any other customary adjunct functions, components and/or elements.

The job queue 10 is shared by a plurality of distinct or separate processes 22 that have access thereto. Optionally, as shown, the processes 22 are created, spawned or launched such that each distinct process 22 works on or performs one or more of a plurality of different tasks for the program 20. Alternately, various ones of the processes 22 sharing the queue 10 may be working for different programs. In either case, it is to be appreciated that while five jobs 12 are illustrated in FIG. 1 for the purposes of simplicity and clarity herein, at any given time as circumstances may dictate, the queue 10 may in practice contain any number of jobs more or less then five, optionally including zero jobs. Additionally, while four processes 22 are illustrated in FIG. 1 for the purposes of simplicity and clarity herein, it is to be appreciate that in practice, at any given time as circumstances may dictate, there may exist more or less then four processes, optionally including zero processes.

Each process 22 with access to the shared queue 10 can selectively modify the queue 10 in accordance with the defined operation of the respective processes 22. Suitably, permitted modifications to the queue 10 by any given process 22 include:
i) adding jobs 12 to the queue 10;
ii) removing jobs 12 from the queue 10;
iii) changing the status/state of an individual job 12 within the queue 10; and,
iv) editing other attributes of each job 12 within the queue 10.
   In practice, the exact definitions of job status/states depends on the software program 20. In the simplest examples, status types may include simply “waiting”, “in progress”, and “completed”. Optionally, each of these may be further subdivided in more elaborate sub-states.

To efficiently share the queue 10 among a plurality of different processes 22, implementation of the queue 10 is optionally devised to allow for parallel or simultaneous access thereto by multiple processes 22. More specifically, the queue 10 is suitably implemented such that: (i) individual jobs 12 (or the objects representing the same) can be added or removed from the queue 10 by different processes 22 without “locking” the entire queue 10; and, (ii) one job 12 in the queue 10 (or the object representing the same) can be modified or accessed by a particular process 12 without “locking” the other jobs 12 in the queue 10 (or the other objects representing the same). In other words, simultaneously, jobs 12 can be added to and/or removed from the queue 10 by different processes 22; different jobs 12 within the queue 10 can be modified and/or accessed by different processes 22; or, some combination thereof.

Of course, with the queue 10 being shared by multiple processes 22 having simultaneous access to the queue 10, there exists the potential to encounter what is known as “race conditions,” which refers to a potentially error-producing situation in which two or more processes (in this case the processes 22) are racing or competing to modify or access the same object (e.g., the same job 12 within the queue 10) at more or less the same time. Left unchecked, race conditions can lead to otherwise undesired results. For example, one process may overwrite another process' earlier change without realizing or intending it. Nevertheless, one or more of a number of techniques are optionally employed in the design of the software program 20 to guard against the potential emergence of race conditions.

Suitably, to protect against race conditions, when a process 22 accesses or modifies a job 12 within the shared queue 10, the object (i.e., the job 12) is optionally locked beforehand so that no other process 22 may access or modify it until it is released or unlock, i.e., until after the prior process 22 is through with it. For example, well known techniques and/or devices such as mutexes and/or semaphores may be employed in the program 20. Alternately, the design of the software program 20 itself may preclude the possibility of race conditions. For example, the program 20 may optionally be designed so that only one process 20 is allowed to do only one type of modification to the queue 20. That is to say, e.g., only one process can add jobs, only one process can remove jobs, and only one process can modify a particular job.

With respect now to the jobs 12, suitably, each job object carries with it all the relevant information and/or data about the job 12. For example, each job 12 optionally describes a task to be performed by a process 22, and the job object suitably contains the definition of the task and/or carries any related job information, e.g., including a set of instructions to run, default and/or other parameters to use when executing the task, user supplied arguments and/or other requests, a time stamp indicating when the job was first created or placed in the queue 10, a status and/or state indicator, etc. In particular, it is convenient if the status/state of the job 12 is indicated in a conspicuous manner. Additionally, the jobs 12 are optionally ordered in the queue 10 linearly or in some other suitable way, so that a process 22 can distinguish between jobs 12 and/or is able to identify which job 12 in the queue 10 should be worked on first or next.

Suitably, to avoid the accumulation of orphan or strayed jobs 12 in the queue 10, the software program 20 is also provisioned with a well-defined mechanism to clean up the queue 10. Optionally, a process 22 is created for or assigned to this duty, and from time to time, it removes jobs 12 from the queue 10 that have aged beyond a set or otherwise determined maximum time limit, e.g., as determined from a job's time stamp.

In one embodiment, the job queue 10, in addition to being a shared queue, is also a persistent queue. In certain respects, a persistent queue can be thought of as a particular kind of shared queue. Persistence is achieved by implementing the queue 10 such that even after the process 22 (or processes) that created and used the queue 10 have ceased to exist, the queue 10 will remain in existence for some time thereafter, so that related or other processes 22 started in the future or otherwise after the fact (i.e., after the previous processes 22 terminated) can continue to use the same queue, e.g., to pick up from where the previous processes 22 may have left off. That is to say, a persistent queue is one that is shared by processes 22 that exist at different and non-intersecting or non-overlapping time periods. Accordingly, the queue 10 is suitably implemented so that it remains in existence independently of the termination of any processes 22 that created or used it.

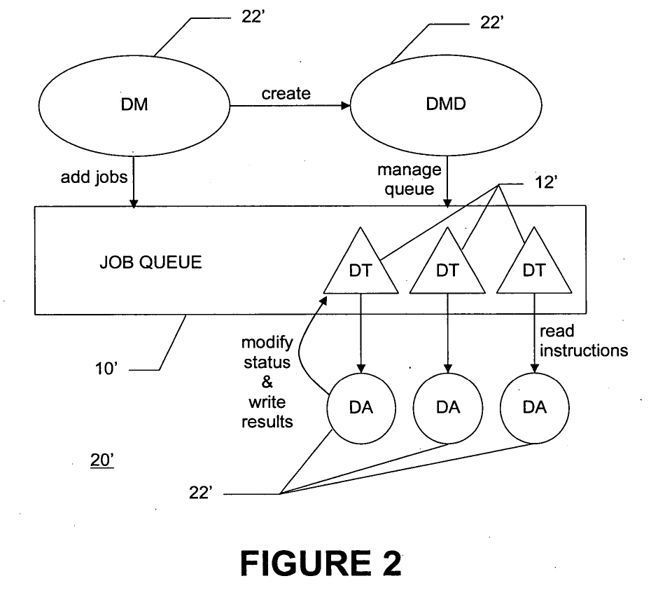

To highlight the various features, benefits and/or other aspects of a shared and persistent job queue, a more specific example of a software program that implements a shared and persistent job queue will now be described with reference to FIG. 2. To maintain consistency with the more general embodiment shown in FIG. 1, like or corresponding elements in FIG. 2 are labeled with primed reference numerals of the same value as in FIG. 1. Of course, it is to be appreciated that the elements in the more specific example of FIG. 2 possess similar features and/or attributes of their corresponding counter parts as described above with reference to the more general example of FIG. 1.

In short, the program 20′ is a tool for diagnostic testing of hardware. It is particularly applicable to running diagnostic tests, either in the foreground or in the background, on telecommunications equipment, e.g., wireless call processing and/or mobility management servers, circuit and/or packet data switching equipment, etc. However, it is similarly suited to other applications in which diagnostic testing of hardware is desired.

Associated with the diagnostic program 20′ are a number of processes 22′, namely, a diagnostic manager (DM), a diagnostic manager daemon (DMD), and a plurality of diagnostic agents (DAs). As shown, the aforementioned processes 22′ share a persistent job queue 10′ containing a plurality of jobs 12′. As before, for simplicity and clarity herein, only a limited number of DAs and jobs have been illustrated. It is to be appreciated, however, that in practice there may be more or less DAs and/or jobs existing at any given time as circumstances dictate.

The DM is the main process 22′ which acts as a front-end user interface. Its primary duty is to receive instructions from a user and respond to them. For example, one of the many user instructions is a request to run a diagnostic test in the background. When such an instruction is received, the DM creates the job queue 10′ and places a job 12′ corresponding to the requested diagnostic test (DT) in the queue. Suitably, the DM returns to its primary duty of waiting for the next user instruction. Accordingly, it does not assume the extra responsibility of managing the job queue 10′. Instead, the DM creates a separate process 22′, namely, the DMD to attend to the management of the job queue 10′. Of course, as time goes on, the user may selectively enter further instructions requesting that background diagnostic tests be run and these are added as separate jobs 12′ to the job queue 10′ by the DM on an as requested basis.

Suitably, the DMD (which is created by the DM whenever circumstances dictate) cycles through the jobs 12′ in the queue one by one (e.g., in a round robin fashion) and attempts to start the diagnostic test corresponding to the job 12′ if possible. It may happen, however, that on occasion the environment dictates that the test be deferred. In which case, the job 12′ will be returned to the queue 10′ and it waits for its turn in the next round. Optionally, the DMD is also responsible for cleaning up the queue from time to time, e.g. to get rid of or eliminate waiting jobs 12′ that have aged beyond a system-specified limit or timeout.

When the DMD finds a job 12′ that can be processed currently, it creates and/or starts yet another process 22′, namely a DA, which is dedicated to executing a single diagnostic test or processing a single job 12′. Suitably, when a DA starts, it charges the status of the associated job 12′ from “waiting” to “checking,” and performs additional checks to see whether there are other reasons to defer the test. If so, the job 12′ is put back into the waiting status and the DA terminates itself. Otherwise, the DA changes the status of the job 12′ to “running” and starts executing the corresponding test. It then waits until the test is completed and records the result to a memory location or the like associated with the job 12′. Optionally, the DA also analyzes the result to determine whether the test passes or fails or is in other categories (e.g. the test may be run only to obtain information). In a suitable implementation, finer classifications of test failing status are defined, e.g., such as whether the test fails due to timeout, or due to excessive output, or being terminated by a signal, etc.

Optionally, when the DA exits or terminates after completing a job 12′, the job 12′ may be considered finished and the job 12′ is removed from the queue 10′ at once. Alternately, however, the job 12′ is permitted to remain in the queue 10′ until the user enters an instruction requesting the output of the corresponding test. The DM then consults the job object, outputs the test result, and records the result in a log file before removing the job 12′ from the queue 10′. The latter alternative, enables the DM to keep track of which tests have not yet been reported back to the user, so that it can remind the user at appropriate times. This can be thought of conceptually as and/or optionally implemented in practice by using two job queues. That is to say, initially all jobs are put into a “waiting” queue, and when a test is completed, the corresponding job is removed from the waiting queue and placed in another queue, e.g., the “to-be-retrieved” queue.

The following table summarizes some of the interactions between the DM, the DMD, the DAs and the job queue.

| Process | Effect/Action | Cause/Reason |
|---|---|---|
| DM | Add job object to | User requests a diagnostic test |
| | queue | |
| | Remove job object | User retrieves the test output |
| | from queue | |
| | Read the job object | To obtain test status and output |
| DMD | Remove job object | The job is too old |
| | from queue | |
| | Modify job status | The status is inconsistent with reality |
| | Read the job status | To determine whether to start a DA to run |
| | | the associated diagnostic test |
| DA | Modify job status | To indicate that job has started, is waiting, |
| | | has completed, etc. |
| | Read the job object | To obtain test definition and other |
| | | environment parameters |

From the description above, one of ordinary skill in the art can appreciate the benefits achieved and/or acknowledge the features permitted by sharing the job queue 10′ among the many processes 22′ that act as the DM, the DMD, and the various DAs. It is also to be appreciated that the program 20′ beneficially implements a queue 10′ that is persistent. For example, a user may start the DM process 22′ and request a few diagnostic tests to be done in the background. The DM then creates the DMD, which in turn creates the DAs. However, the user may not wait for all the tests to complete. Instead, the user may quit the DM and attend to other business. In the meantime, the DMD continues to exist until all the tests are completed or otherwise terminated. If the user comes back after that time, then the DMD and all the DAs will have already gone out of existence, perhaps even for quite a long while. The user then starts a new DM (i.e., a process 22′ not existing in a time period overlapping with the existence of any prior process 22′ that created or used the queue 10′) to retrieve the outputs or results from the earlier requested and/or run tests. If the queue 10′ ceased to exist upon the termination of the prior processes 22′ that first created and/or used the queue 10′ (i.e., if the queue 10′ were not persistent), then those outputs and/or results would not be available. However, being that the queue 10′ is in fact implemented to be persistent, the new DM is still able to access the queue 10′ and retrieve the information.

In one exemplary embodiment suitable for implementing jobs 12 within the shared and persistent queue 10, the jobs 12 are represented by and/or implemented as individual objects in a persistent or non-volatile memory or storage location outside of any of the processes 22. Optionally, jobs 12 belonging to the same queue 10 are grouped together in the same logical location, e.g., so that they can be found easily. Suitably, the jobs 12 are named according to the following convention:
i) part of the name contains a serial number that indicates the linear and/or other respective ordering of the job;
ii) part of the name is used to indicate the job status;
iii) part of the name is used to identify the queue to which it belongs; and,
iv) part of the name is used to identity the job itself.

Optionally, related queues may reside in the same location. If they do, the job names (see item (iii) above) are used to sort them out easily. Additionally, each job 12 optionally has associated therewith a memory location that can be used to store other information related to the job 12. Suitably, both the name and the associated information of a job 12 may be selectively modified by a process 22. Recall that different jobs 12 can be independently modified and/or accessed by different processes 22 simultaneously. In other words, if one process 22 is modifying one job 12, only that one particular job 12 is locked to avoid race conditions; other processes 22 are therefore allowed to modify other jobs 12 at the same time.

In one exemplary embodiment, a file is used to represent a job 12. Job files of the same or related queues are stored in a directory designated by the software program 20. For example, in accordance with the foregoing exemplary naming convention, each job name takes the form NNN_JJJJ.QQS, where NNN is a three-digit serial number, JJJJ is a string describing the diagnostic test and/or identifying the job 12, QQ is the name of the queue (e.g., “bg” may be used as a mnemonic for a queue containing jobs for diagnostic test run in the “background”), and S is a one-character code indicating a job's status or state (e.g., such as “w,” for waiting, “c” for checking, “r” for running, “f” for test failed, “p” for test passed, “k” for test killed, “t” for test timed-out, etc.). Suitably, the content of each job file contains the definition of the diagnostic test (including instructions to run the test and default environment parameters), additional arguments that the user supplies to the test, other user requests to change some environment parameters, and a time stamp. Modern scripting languages, such as perl, is optionally used to carry out the implementation. Advantageously, manipulations of such shared queues are also readily accomplished by utility subroutines written in these languages.

Of course, there are a number of other suitable ways to achieve the foregoing implementation of jobs 12 within the queue 10. One alternative approach is to use the IPC technique of “shared memory” to implement the job names in a queue, and to use a pointer to associate each job name with a different chunk of memory to store information for the job. Although this is a possible approach, the fact that there can be a variable number of jobs present at any time and that there may be a variable amount of information associated with each job makes the coding much more complicated. In addition, it takes more work to lock individual items represented in a shared memory.

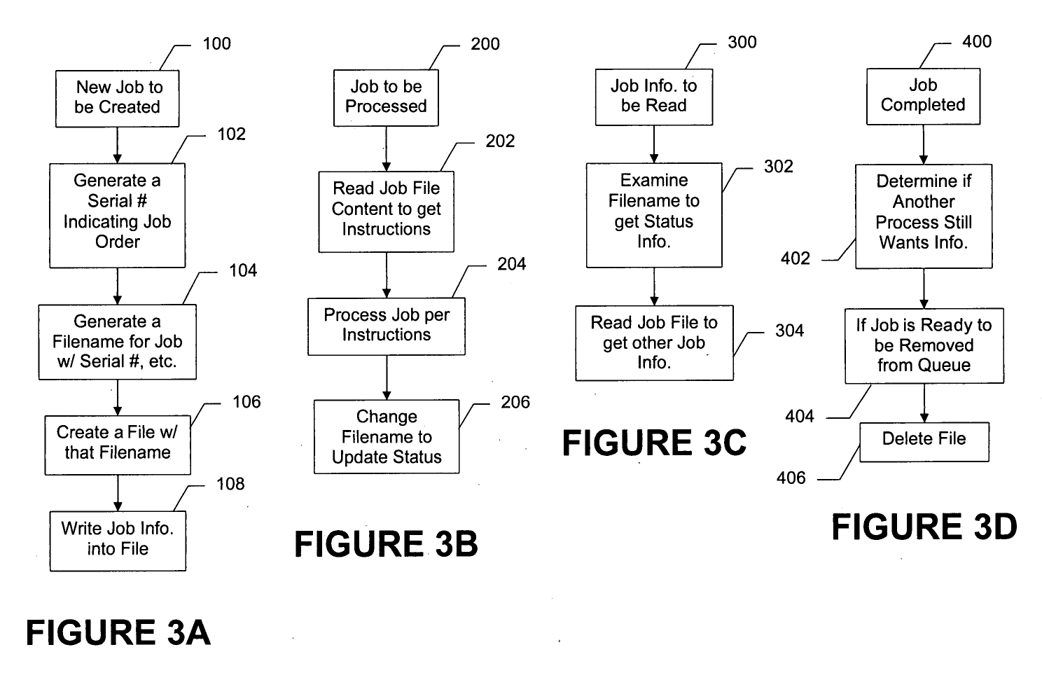

With reference to FIG. 3A, there is shown an exemplary approach to creating a new job 12 using the job queue implementation described above. At step 100, instructions are received and/or a request is entered to the program 20 initiating the creation of a new job-12. At step 102, suitably a serial number is determined or generated that indicates the order of the job 12. At step 104, a file name for the job is generated or constructed, e.g., including the serial number from step 102, a job name, a queue name, an initial status identifier, etc. At step 106, a file is created with the file name from step 106. For example, the file is optionally created in a designated directory. Finally, at step 108, the job information is written into the file created in step 106.

With reference to FIG. 3B, there is shown an exemplary approach to processing a job 12 from the job queue 10 in accordance with the job queue implementation described above. At step 200, it is determined that a job 12 is ready to be acted upon by a process 22. At step 202, the job file is read by the process 22 to get the instruction therefrom. At step 204, a job is executed per the obtained instruction. Finally, at step 206, the job filename is changed if applicable to update the status indicator.

With reference to FIG. 3C, there is shown an exemplary approach to a job results in accordance with the job queue implementation described above. At step 300, it is determined that a job results are ready to be obtained, e.g., in response to a user request for the same. At step 302; the status of the job 12 is obtained by examining the job filename. Finally, at step 304, the job file content is read to obtain other relevant job information and/or results.

With reference to FIG. 3D, there is shown an exemplary approach for removing a completed job 12 from the job queue 10 in accordance with the job queue implementation described above. At step 400, it is determined that a job 12 is completed, e.g., by checking the status indicator in the job filename. At'step 402, it is determined if any of the job information may still be wanted by another process 22. If, as shown at step 404, the job is ready to be removed from the queue 10, then finally, at step 406, the job file is deleted.

To continue with the example shown in FIG. 2, the diagnostic software program 20′ is optionally coded using the perl language. Alternately, however, most other popular scripting languages, such as python, tcl, and ruby, may be used for this purpose. However, perl provides an advantage over the lower-level compiled languages, such as C, because perl possesses many convenient, high-level built-in utility subroutines for manipulating files, directories, arrays of variables, etc. that can save significant time in developing the software. For instance, using perl, files can easily be added, removed, or edited; files in a directory Whose name contains a certain string pattern can be listed; a list of file names can be easily sorted in alphabetical or numerical order; etc.

In connection with the exemplary program 20′, a designated directory on the file system (nominally called the job directory) is used to place the job objects in the queue (or queues). Optionally, this directory is not used by any other software program, or by the program 20′ for purposes other than job queue processing.

Suitably, the DM process 22′ maintains an internal variable containing the next test number. A three-digit serial number is optionally used for this purpose (e.g., from 001 up to 999), and the tests are numbered sequentially. When a test has the number 999, the next test will be given the number 001 (i.e., in round-robin fashion). This numbering method has been found valid based on experience that indicates in most applications there tends to be far fewer than a hundred jobs in the queue at any given time. However, depending upon the application, more or less digits may be employed in the serial number as appropriate.

When the user requests a background diagnostic test, the DM assigns a name to the test, e.g., in accordance with the convention described above, and increments the internal variable. For example, initially, the file name is given the extension .bgw to indicate that this is a job waiting to be run in the background queue. The DM then creates a job file with the appropriate name in the job directory and writes all the necessary information associated with the test into the file, coded, e.g., in the perl language format. This format allows any process 22′ that wants to-retrieve information about the job 12′ later to simply call a built-in perl subroutine to get the pertinent information loaded into the process 22′ and be readily available to the program 20′.

Another function of the DM is to display the output of a previous test upon the user's request. Suitably, the DM goes to the job directory and scans the file names found there. If the job 12′ is found in the queue 10′ with a status indicating that the test has completed, the DM will read the file to find out the test result and display that. Suitably, the DM then records the result in a log file and finally removes the file. Alternately, if the job 12′ is found in the queue 10′ but the status indicates that the test has not completed yet, the DM will relate that information back to the user. Finally, if the job 12′ is not found in the queue 10′, that means the job 12′ has already been removed from the queue some time ago. Optionally, the DM then searches the log file to find and display the corresponding test results.

Recall, the DMD is created by the DM as a separate process 12′ whenever circumstances dictate. Suitably, the DMD scans file names in the job directory and determines what to do with the files. For example, the following steps are repeated until all jobs 12′ in the queue 10′ have been addressed. If a file is found to be too old, the file is removed optionally after some appropriate actions. The DMD also suitably finds all the jobs 12′ with a status indicating that the job 12′ is being handled by a DA. For example, this is readily done with a command that lists all files in a directory whose name contains a given string pattern. For each of these jobs 12′, the DMD will verify that the corresponding DA is really there. Note, this is a precaution step taken to remedy the rare situations in which a DA may have been inadvertently terminated without having a chance to update the status of the job. If such a case is discovered, the status of the job 12′ in question can be corrected, for example, by putting it back to the waiting status waiting for another DA to be created later to rerun the test.

Suitably, the DMD also finds all the jobs 12′ in the queue 10′ that are waiting to be executed, and it optionally sorts the jobs 12′ in the order specified by the serial number in the file name. For example, the sorting utility-of per[ is very efficient and easy to use for this purpose. The DMD then goes through the waiting jobs one by one in the sorted order, to check if it is a good time to start the job 12′. If so, the DMD creates a DA to handle the job 12′. If not, the DMD skips the job 12′ and moves to the next one. Note, to manage the job queue 10′ in the manner described (i.e., to clean out old jobs, correct erroneous status indicators, sort jobs, etc.), the DMD only has to know the name of a job file and its creation time. That is to say, the DMD does not have to read the contents of each job file.

With respect to the DAs, suitably they neither create nor remove any jobs 12′, and each one only has to deal with that one particular job 12′ assigned to it by the DMD. In operation, the DA loads the job file, thereby 30 obtaining the definition of the diagnostic test, the environment parameters and any additional arguments to be applied to the test. Suitably, the DA promotes the job status to “checking,” by simply renaming the file, in the present example, by changing the file name extension from .bgw to .bgc. The DA then checks the environment and any other conditions as stipulated by the program 20′ (e.g., this may be done by consulting with another external program) to see if it is suitable to run the test now. It not, the DA demotes the status of the job back to “waiting” and then exits. If yes, the DA follows the instructions given in the definition of the test to run the test and captures the output. Optionally, the DA then determines whether the test passes, fails, or falls into other categories according either to the program 20′ or the instructions given in the definition of the test. It appends the test output and test result to the existing content of the job file and modifies the job status accordingly.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that some elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. In a software program, a method for implementing a job queue shared by a plurality of distinct processes, said method comprising:
(a) adding a plurality of distinct jobs to the queue; and,
(b) providing the plurality of processes access to the job queue such that two different processes may simultaneously manipulate two different jobs contained in the job queue.

2. The method of claim 1, wherein the job queue is persistent such that it is shared by at least two processes that exist at two different and non-intersecting time periods.

3. The method of claim 1, further comprising:
providing a process to remove from the queue jobs that have been completed or aged beyond a specified threshold.

4. The method of claim 1, wherein adding a job to the queue comprises:
placing in the queue a corresponding job object that carries a set of instructions for executing the job.

5. The method of claim 4, wherein placing a job object in the job queue comprises:
puffing the job object in a non-volatile storage location outside of the processes sharing the job queue.

6. The method of claim 5, wherein the job object is a job file having contents that include the set of instruction.

7. The method of claim 6, further comprising:
naming the job file in accordance with a specified naming convention such that at least a part of a filename for the job file indicates a status of the job.

8. The method of claim 6, further comprising:
naming the job file in accordance with a specified naming convention such that at least a part of a filename for the job file indicates an order in which the job is to be processed.

9. The method of claim 6, wherein the job file is put in a directory of a file system, said directory being dedicated to the job queue.

10. A software program running on a device to perform diagnostic tests, said software program comprising:
a main process that acts as an interface with a user, said main process having as its responsibility receiving requests for tests from the user such that upon receipt of a request for a test the main process places a corresponding job associated with the test in a job queue;
a daemon process which is launched by the main process to manage the job queue, said daemon process determining when jobs in the job queue are ready to be processed; and,
a plurality of distinct agent processes that are launched by the daemon process when the daemon process determines that jobs are ready to be processed, each of said agent processes being dedicated to processing a single job so as to run the test associated with the job;
wherein the job queue is implemented so that any two different processes may simultaneously manipulate any two different jobs.

11. The software program of claim 10, wherein the job queue persistent after a termination of the main process, the daemon process and the agent processes.

12. The software program of claim 10, wherein the job queue is implemented so that jobs may be selectively added or removed from the queue without restricting processes from accessing other jobs in the job queue.

13. The software program of claim 10, wherein the daemon process is responsible for removing jobs from the job when they have aged beyond a specified threshold.

14. The software program of claim 10, wherein the job queue is implemented so as to remain in existence independently of any processes that created or used it.

15. The software program of claim 10, wherein the program is coded using a scripting language.

16. The software program of claim 15, wherein the scripting language is python, tcl, ruby or perl.
